(19) United States
(12) Patent Application Publication
(10) Pub. No.: US 2017/0050520 A1
(43) Pub. Date: Feb. 23, 2017

(54) INSTRUMENT INDICATOR NEEDLE DEVICE PROVIDING VISUAL INDICATION OF INSTANTANEOUS FUEL ECONOMY

(71) Applicant: FORD GLOBAL TECHNOLOGIES, LLC, Dearborn, MI (US)

(72) Inventors: David Huelke, Milan, MI (US); Eric Axel Smitterberg, Berkley, MI (US)

(21) Appl. No.: 14/829,221

(22) Filed: Aug. 18, 2015

(51) Int. Cl. B60K 35/00; B60Q 9/00

(52) U.S. Cl. CPC B60K 35/00; B60Q 9/00

(57) ABSTRACT

A device is provided for the purpose of displaying the instantaneous fuel economy of a motor vehicle. That device includes an indicator having indicia on a fascia and an indicator needle. That indicator needle includes an outline which contrasts with the fascia and a plurality of differently-colored segments. The controller determines the instantaneous motor vehicle fuel economy and illuminates the plurality of differently-colored segments to provide a visual indication of instantaneous motor vehicle fuel economy.

### TECHNICAL FIELD

This document relates generally to the motor vehicle equipment field and, more particularly, to an instrument indicator needle device that provides a visual indication of the instantaneous fuel economy of a motor vehicle. Such a device provides the necessary information to allow a motor vehicle operator to develop improved driving habits for increasing the fuel economy of the motor vehicle.

### BACKGROUND

Motor vehicle instruments on the instrument panel of a motor vehicle provide a vast array of information to the driver of the vehicle including, for example, speed, engine revolutions, remaining fuel, oil pressure, engine operating temperature, engine oil temperature and the like. Gauges have also been developed to provide an indication of the instantaneous fuel economy provided by the motor vehicle as it is being driven by the operator. Unfortunately, separate gauges of this type add clutter to the instrument panel and may distract the driver from monitoring the road or other more important instruments such as the speedometer.

This document relates to a new and improved device for providing a visual indication of the instantaneous fuel economy of the motor vehicle that may be incorporated into an existing instrument such as a speedometer, tachometer, a fuel level gauge or other instrument commonly associated with the operation of a motor vehicle.

### SUMMARY

In accordance with the purposes and benefits described herein, a new and improved device is provided for a motor vehicle that is specifically adapted to provide a visual indication of the instantaneous fuel economy of the motor vehicle as it is being driven by the operator. That device comprises an instrument including indicia on a fascia and an indicator needle. The indicator needle includes an outline which contrasts with the fascia and a plurality of differently-colored segments. A controller is also provided for determining instantaneous motor vehicle fuel economy and illuminating the plurality of differently-colored segments to provide a visual indication of instantaneous motor vehicle fuel economy to an operator while the operator monitors the instrument in question for other vehicle operating parameters such as speed, engine revolutions, fuel level and the like.

In one possible embodiment, the plurality of differently-colored segments are provided within an outline on the indicator needle. Further, those plurality of differently-colored segments include a first segment having a first color, a second segment having a second color and a third segment having a third color wherein the first, second and third colors are all different. In one particularly useful embodiment, the first color is green, the second color is yellow and the third color is red. Further, the fascia is white and the outline of the indicator needle is black.

In one possible embodiment of the invention, the instrument is a speedometer. In another possible embodiment of the invention, the instrument is a tachometer. In yet another possible embodiment of the invention, the instrument is a fuel gauge.

In accordance with an additional aspect, a motor vehicle is provided incorporating the device just described for providing a visual indication of instantaneous fuel economy.

In accordance with still another aspect, a method is provided for displaying instantaneous fuel economy on an instrument of the motor vehicle. The method comprises the steps of providing an indicator needle of the instrument with (a) an outline that contrasts with the fascia of the instrument and (b) a plurality of differently-colored segments. Further, the method includes illuminating the plurality of the colored segments in different ways in order to give a visual indication of instantaneous fuel economy for the motor vehicle. Still further, that method may include locating the plurality of differently-colored segments within an outline on the indicator needle.

Further, the method may include providing a green segment, a yellow segment and a red segment.

In accordance with still another aspect, an instantaneous fuel economy display system is provided. That display system comprises an indicator needle for an instrument. The indicator needle includes an outline having a color that contrasts with the fascia of the instrument and a plurality of differently-colored segments within the outline for indicating instantaneous fuel economy. Further, the system may include a controller for determining instantaneous motor vehicle fuel economy and illuminating the plurality of differently-colored segments to provide a visual indication of the instantaneous motor vehicle fuel economy to an operator.

In the following description, there are shown and described several preferred embodiments of the device for providing visual indication of instantaneous fuel economy. As it should be realized, the device is capable of other, different embodiments and its several details are capable of modification in various, obvious aspects all without departing from the device as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the device for providing a visual indication of instantaneous fuel economy and together with the description serve to explain certain principles thereof. In the drawing figures:

FIG. 1 is a is a front plan view of the instrument panel of a motor vehicle including the instrument indicator needle device that provides a visual indication of the instantaneous fuel economy of the motor vehicle.

FIG. 2 is a block schematic diagram of one possible controller for the device illustrated in FIG. 1.

Reference will now be made in detail to the present preferred embodiments of the device providing a visual indication of instantaneous fuel economy, examples of which are illustrated in the accompanying drawing figures.

### DETAILED DESCRIPTION

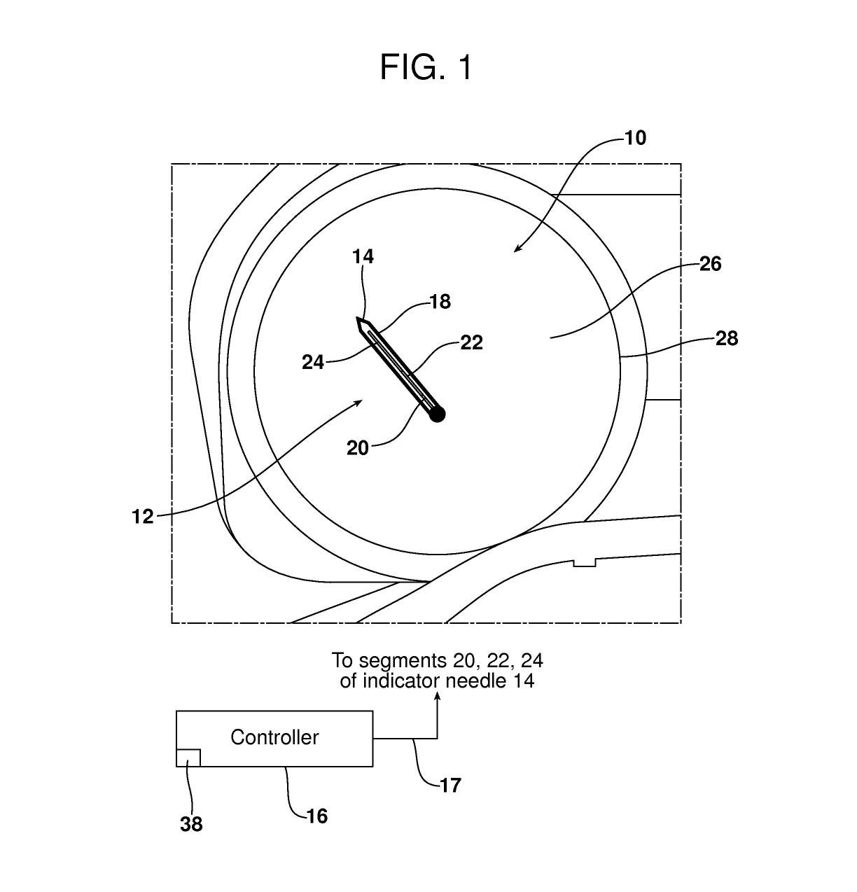

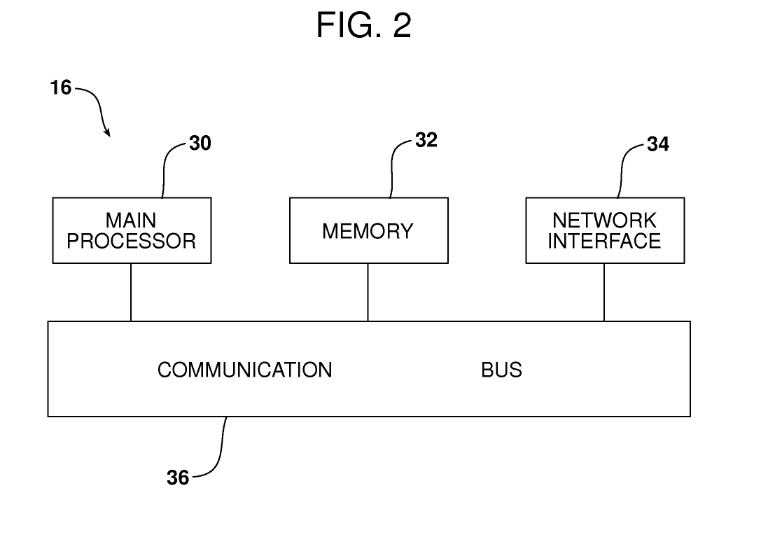

Reference is now made to FIGS. 1 and 2 illustrating a device 10 for providing a visual indication of the instantaneous fuel economy of a motor vehicle in an efficient and quickly recognized manner. The device 10 incorporates an instantaneous fuel economy display system 12 including an indicator needle 14 and a controller 16 operatively connected to the indicator needle by control line 17. The indicator needle 14 has a body including an outline 18 and a plurality of differently-colored segments 20, 22, 24 for indicating the instantaneous fuel economy of the motor vehicle in a manner that will be described in greater detail below.

In the illustrated embodiment, the plurality of differently-colored segments 20, 22, 24 are provided on the body of the indicator needle 14 inside the outline 18. In one particularly useful embodiment, the first segment 20 is green, the second segment 22 is yellow and the third segment 24 is red. Further, the outline is of a color contrasting with the fascia 26 of the instrument 28 into which the indicator needle 14 is incorporated. Thus, for example, the outline may be black while the fascia may be white. That instrument may comprise a speedometer, a tachometer, a fuel gauge or any other instrument or gauge commonly associated with a motor vehicle.

When the operator of the motor vehicle is operating the motor vehicle in a most fuel efficient manner, the first or green color segment 20 is illuminated. The segment 20 gives an indication of fuel efficient operation of the motor vehicle that is quickly and easily recognized.

In contrast, when the operator of the motor vehicle is operating the motor vehicle in a manner that reduces fuel economy by a first predetermined factor, the controller 16 illuminates the second segment 22 which, in the illustrated embodiment, illuminates in a yellow color thereby providing the operator with a visual indication cautioning the operator that the motor vehicle is no longer being driven in the most efficient manner possible.

Still further, when the motor vehicle operator is operating the motor vehicle in a spirited manner which reduces the instantaneous fuel economy by a second predetermined factor greater than the first predetermined factor, the controller 16 illuminates the third segment 24 within the outline 18 on the indicator needle 14. In the illustrated embodiment, the third segment 24 illuminates in a red color, thereby providing a vehicle operator with a visual indication that the motor vehicle is being operated in a way that minimizes the potential fuel economy of the motor vehicle.

As should be appreciated, as the visual indication of fuel economy is instantaneous with the manner in which the motor vehicle is being operated, the visual display provided on the indicator needle 14 by means of the first, second and third segments 20, 22, 24 allows an operator to learn how to operate the motor vehicle with maximum efficiency at all times, thereby improving fuel economy and reducing the cost of operating the motor vehicle.

While the illustrated embodiment shows three differently-colored segments 20, 22, 24, it should be appreciated that a greater or lesser number of segments along with a correspondingly greater or lesser number of instantaneous fuel economy ranges may be utilized for the purposes of providing a greater or lesser degree of specificity in displaying instantaneous fuel economy to the operator of the motor vehicle. Further, it should be appreciated that the limits of the three ranges above may vary with respect to the absolute speed of the motor vehicle in order to provide a more accurate display of the efficiency of the motor vehicle operation. Thus, spirited operation of the motor vehicle at a low absolute vehicle speed may result in the display indicating inefficient operation even if the instantaneous fuel economy is greater than at steady highway speeds.

The controller 16 for the device 10 may comprise a computing device such as a dedicated microprocessor, an electronic control unit (ECU) running appropriate software or the like. As illustrated in FIG. 2, the controller 16 may include one or more processors 30, one or more memories 32 and one or more network interfaces 34. As should be appreciated, all of these components 30, 32, 34 may communicate with each other over a communication bus 36. As further illustrated, the controller 16 may also have an input 38 connected to another control module, such as a body control module (BCM) (not shown) that provides instantaneous fuel economy data for the motor vehicle.

In summary, the device 10 and system 12 provide a very effective way to efficiently inform the operator of the instantaneous fuel economy of the motor vehicle as well as train the operator in responsible driving habits and thereby maximize the motor vehicle's fuel economy. By noticing the multicolor display on the indicator needle 14 of the speedometer, tachometer, fuel level gauge or other instrument, the operator may quickly and conveniently determine the operating efficiency of the vehicle with minimal distraction. Advantageously, there is no need for a second, separate fuel economy gauge, both reducing distraction and reducing the space required for on the motor vehicle instrument display panel.

The device 10 and instrument fuel economy display system 12 are characterized by a method of displaying instantaneous fuel economy which may be described as including the step of providing an indicator needle 14 of an instrument 28 with (a) an outline 18 that contrasts with a fascia 26 of the instrument and (b) a plurality of differently-colored segments 20, 22, 24. That method also includes the step of illuminating the plurality of differently-colored segments 20, 22, 24 in different ways in order to give a visual indication of the instantaneous fuel economy of the motor vehicle. The method may be further described as including the step of locating the plurality of differently-colored segments 20, 22, 24 within the outline 18 on the indicator needle. Further, in one possible embodiment a first segment 20 in green, a second segment 22 in yellow and a third segment 24 in red are provided.

The foregoing has been presented for purposes of illustration and description. It is not intended to be exhaustive or to limit the embodiments to the precise form disclosed. Obvious modifications and variations are possible in light of the above teachings. For example, although all the embodiments illustrated and described above include a green segment 20, a yellow segment 22 and a red segment 24, those segments may be provided in different colors if desired, or provided in the same colors oriented in a different order. For example, the three segments 20, 22, 24 could be provided parallel to one another along the length of the indicator needle within the outline 18. Further, it should be appreciated that the indicator needle 14 may be provided in more than one instrument at one time. Thus, an indicator needle 14 providing a visual indication of instantaneous fuel economy in a manner described above could be provided in both the speedometer and tachometer instruments 28 (see FIG. 4). All such modifications and variations are within the scope of the appended claims when interpreted in accordance with the breadth to which they are fairly, legally and equitably entitled.

What is claimed:

1. A device for a motor vehicle, comprising:
an instrument including indicia on a fascia and an indicator needle, said indicator needle including an outline that contrasts with said fascia and a plurality of different colored segments; and
a controller for determining instantaneous motor vehicle fuel economy and illuminating said plurality of different colored segments to provide a visual indication of instantaneous motor vehicle fuel economy to an operator.

2. The device of claim 1 wherein said plurality of different colored segments are provided within said outline.

3. The device of claim 2, wherein said plurality of different colored segments includes a first segment having a first color, a second segment having a second color and a third segment having a third color wherein said first color, said second color and said third color are all different.

4. The device of claim 3, wherein said first color is green, said second color is yellow and said third color is red.

5. The device of claim 4, wherein said fascia is white and said outline is black.

6. The device of claim 5, wherein said instrument is a speedometer.

7. The device of claim 5, wherein said instrument is a tachometer.

8. The device of claim 5, wherein said instrument is a fuel gauge.

9. The device of claim 1, wherein said plurality of different colored segments includes a first segment having a first color, a second segment having a second color and a third segment having a third color wherein said first color, said second color and said third color are all different.

10. The device of claim 9, wherein said first color is green, said second color is yellow and said third color is red.

11. The device of claim 1, wherein said fascia is white and said outline is black.

12. The device of claim 1, wherein said instrument is a speedometer.

13. The device of claim 1, wherein said instrument is a tachometer.

14. The device of claim 1, wherein said instrument is a fuel gauge.

15. A motor vehicle incorporating the device of claim 1.

16. A method of displaying instantaneous fuel economy on an instrument of a motor vehicle, comprising:
providing an indicator needle of said instrument with an outline that contrasts with a fascia of said instrument and a plurality of different colored segments; and
illuminating said plurality of different colored segments in different ways in order to give a visual indication of instantaneous fuel economy of said motor vehicle.

17. The method of claim 16 including locating said plurality of different colored segments within said outline on said indicator needle.

18. The device of claim 17, including providing a green segment, a yellow segment and a red segment.

19. An instantaneous fuel economy display system, comprising:
an indicator needle for an instrument, said indicator needle including an outline having a color, contrasting with a fascia of the instrument, and a plurality of different colored segments within said outline for indicating instantaneous fuel economy.

20. The instantaneous fuel economy display system of claim 19 further including a controller for determining instantaneous motor vehicle fuel economy and illuminating said plurality of different colored segments to provide a visual indication of instantaneous motor vehicle fuel economy to an operator.
